(19) United States
(12) Patent Application Publication
(10) Pub. No.: US 2010/0331016 A1
(43) Pub. Date: Dec. 30, 2010

(54) LOCATION-BASED PROMOTION FOR A MOBILE COMMUNICATION NETWORK

(75) Inventors: KEITH DUTTON, Santa Barbara, CA (US); Aric Coady, Ojai, CA (US); David Pisoni, Torrance, CA (US); William E. Woody, Glendale, CA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: Geodelic, Inc., Santa Monica, CA (US)

(21) Appl. No.: 12/789,420

(22) Filed: May 27, 2010

Related U.S. Application Data
(60) Provisional application No. 61/181,648, filed on May 27, 2009.

(51) Int. Cl. H04W 64/00

(52) U.S. Cl. 455/456.3

(57) ABSTRACT

Methods and systems for location-based promotions are presented. A location of a mobile device is determined and transmitted to a server computer via a wireless communications network, along with user identification information. One or more location-based applications are run on the mobile device. At least one of the applications receives location-based content based on a context determined by the server computer. The location-based content including a promotion for a location associated with the location-based content. The application further executes a promotional function based on the promotion.

### CROSS REFERENCE TO RELATED APPLICATIONS

This application claims the benefit of priority under 35 U.S.C. §119 to U.S. Provisional Patent Application Ser. No. 61/181,648, filed on May 27, 2009, entitled, “Location Discovery System And Method”, the entire disclosure of which is incorporated by reference herein.

### BACKGROUND

This disclosure relates generally to mobile communications, and more particularly to a mobile communications network that provides dynamic and contextual discovery of geo-tagged items of interest, and provides information about discovered items of interest to a mobile device based on a user's location, context (speed, direction, distance traveled, temperature, etc. . . . ) affinities and time.

Modern mobile devices, such as cell-phones, smart phones, tablet computers, etc., are capable of broadband-speed, content-rich data communications. These devices are also capable of continuously providing their precise geographic location, which has enabled various so-called location-based services (LBS). LBS is a feature of modern mobile devices in which the actual geographic position of the mobile device is determined—by Global Positioning System (GPS), WiFi, or other technology—and used for a variety of applications, from finding the nearest restaurant to location-specific weather forecasting.

The past several years have witnessed a dramatic increase in the “mobile web,” i.e., the use of mobile devices to access and retrieve data from the World Wide Web (“Web”) via wireless mobile communication networks. While many service providers purport to provide LBS in information access and retrieval applications, location information is typically merely combined with search terms of a static textual query to the Web, generating only marginally more useful results for a user. For instance, a user of a mobile device in Santa Monica, Calif. can enter a search query of “sushi restaurants” and, based on that user's location from GPS information, an LBS-type application can return a list to the mobile device of sushi restaurants within a certain geographic range of Santa Monica, Calif. Further, these results usually terminate the query process, and more information related to the query is not provided.

### SUMMARY

In general, this document discloses a system and method for dynamic, contextual generation of promotions for a mobile communications network, and delivery of the promotions to a mobile device. More specifically, a system and method enables generation of promotions for a mobile device user based on location, affinities and time, which promotions are further enhanced by location type, user behavior and preferences, information source, contextual promotions by information providers, user customized views on the mobile device, and establishment of continuing communication channels between the promotions and the user via the mobile device.

In one aspect, a method includes receiving, at a computer, location information associated with a mobile device, and determining, by the computer, a context associated with the mobile device. The method further includes sending the context to a content source, and determining, by the content source, location-based content based on the context. The location-based content includes a promotion for a location associated with the location-based content. The method further includes transmitting, from the content source via a mobile communications network, the location-based content to an application running on the mobile device, where the application is configured to display a representation of the location-based content on a display of the mobile device and to execute a promotional function based on the promotion.

In another aspect, a method includes determining a location of a mobile device, transmitting location information associated with the location to a server computer via a wireless communications network, and transmitting user identification information associated with a user of the mobile device to the server computer via the wireless communications network. The method further includes running one or more location-based applications on the mobile device, and receiving, by at least one of the one or more location-based applications from the server computer via the wireless communications network, location-based content based on a context determined by the server computer. The location-based content includes a promotion for a location associated with the location-based content. The method further includes executing, by the at least one application, a promotional function based on the promotion.

In yet another aspect, a method includes running one or more location-based applications on the mobile device, and receiving, by at least one of the one or more location-based applications from a server computer via the wireless communications network, location-based content based on a context determined by the server computer. The location-based content includes a promotion associated with the location-based content, and the context is based on a location of the mobile device and a historical profile of a user of the mobile device. The method further includes accessing, by the at least one location-based application, the location-based content to execute the promotion to generate a promotional function that is personalized for the user of the mobile device based on the context. The method further includes executing, by the at least one application, the promotional function based an input from the user of the mobile device.

The details of one or more implementations are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a server environment of a location discovery system.

FIG. 2 illustrates a location taxonomy used by the system.

FIG. 3 illustrates a user interface on a mobile device of a location discovery system.

FIG. 4 illustrates a display of aggregated content for a specific location.

FIG. 5 is a flowchart of a method for determining a relevance of content for delivery to a mobile device.

FIG. 6 is a block diagram of a system for determining and transmitting location-based content.

FIG. 7 shows various representations of a user interface of a mobile device generated by the location discovery system.

FIG. 8 is a functional block diagram of a data input system for location-based content.

FIG. 9 is a functional block diagram of a promotions contextual application environment.

FIG. 10 is a diagram illustrating the generation and distribution of a coupon.

Like reference symbols in the various drawings indicate like elements.

### DETAILED DESCRIPTION

This document describes systems and methods for dynamic, contextual promotions for a mobile device based on a location and context of the mobile device. A location can be an area such as a geographical area or a socio-politically-defined area like a city or town, a commercial or service establishment such as retail location or recreation site, an attraction, or any other type of physical or information-based place of interest. The system and method enable discovery of information for the promotion based on location and affinities of a user of the mobile device, as well as a time in which discovery is executed. Implementations of the system and method provide for enhanced location-based content delivery to a mobile device based further on location type, user behavior and preferences, information, source, contextual promotions by information providers, user customized views on the mobile device, and establishment of continuing virtual communication channels between discovered information and the user via the mobile device.

The system and method combine accurate global positioning data, mobile browsing information, and content-rich mobile data communication for dynamic and contextual mobile discovery of Places of Interest (POIs) and other geo-tagged items (collectively called “discoverables”), information about which is processed by a relevance engine, aggregated for delivery to a mobile device, and formatted for display on the mobile device. In particular, this document describes a location discovery system and method, used with a mobile device, with which information about locations, content, users, and interests are associated according to techniques to determine information most relevant to a particular user at a specific location and specific time(s). The system allows users to discover and navigate their surroundings on GPS or other geo-location-enabled mobile devices, and adapts to user behavior and operation history of the mobile device over time to provide an increasingly personalized and targeted experience.

By correlating contextual elements and application usage patterns, a location discovery system and method automatically enhances user affinity profiles, and thus user relevance. Meanwhile, behavior analysis continually improves both the collective experience and the user experience. Location-aware mobile devices enable the selective “push” (information delivered without specific user input such as search keywords) of location-based information or contextual applications or contextually relevant interactivity for use with a local application on the mobile device. The contextual applications and interactivity can take the form of discreet applications written for a particular operating system's software development kit (SDK), or may be a feature-rich web page executing in a local browser application, such as can be implemented using HTML5, for example. In some implementations, the local application is running within a browser, while in other implementations, the local application is run with native code on the Operating system of the device, which may also be communicating with a browser.

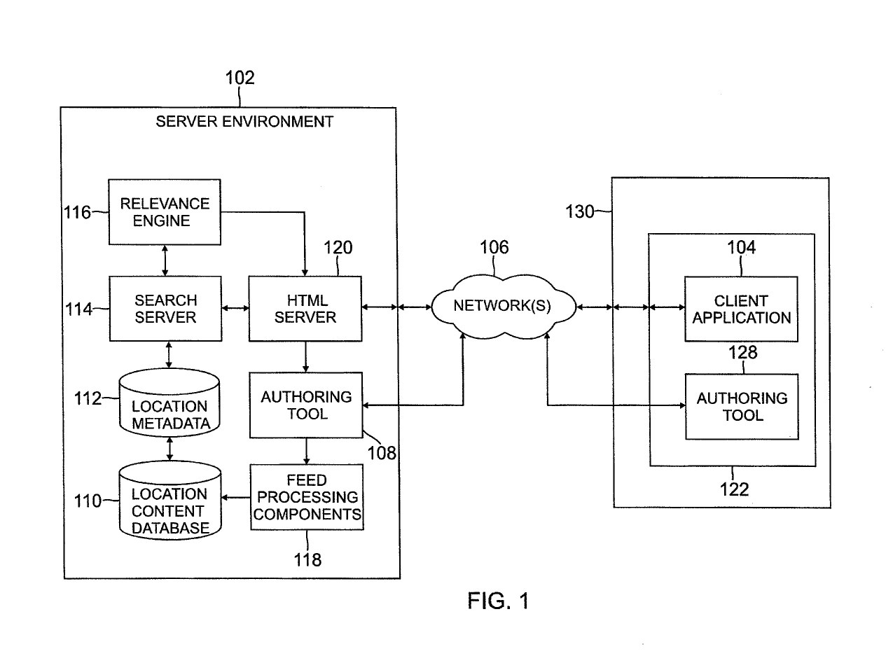

FIG. 1 is a functional block diagram of a location discovery system 100 that includes a server environment 102 and one or more client applications 104. Each client application 104 communicates with the sever environment 102 via proprietary Application Programming Interfaces (APIs) through communication networks 106. The server environment 102 includes an authoring tool 108 for receiving content from administrators, branding partners, location administrators, and even users, from a client application. Feed processing components 118 normalize data feeds from multiple sources to build aggregated databases of POIs for use in the location discovery system 100.

The server environment 102 further includes a location content database 110 and location metadata 112 that describes the content in the location content database 110. The location content database 110 can store usage patterns and affinity profiles for users of the location discovery system 100, which can be mapped to contextual elements of the location content stored in the location content database 110. The location content database 110 is an aggregated database of all locations, i.e. POIs, and can be user extensible. The content in the location content database 110 is organized according to a customized taxonomy and ontology scheme, whereby content can be organized according to categories, specific products or services, activities, indoor or outdoor locations, amenities of a location, or other location types, etc. The location metadata 112 can include tags such as geotags (geographic location metadata) and other tags provided by authoring tool 108. A proprietary data mapping schema ties the taxonomy to content in the location content database 110 and location metadata 112, as well as other content sources, such as third party search engines, recommendation websites, vertical sources, etc.

The server environment 102 further includes a search server 114 that executes searches specified by a user of the client application 104, and a relevance engine 116 which cooperates with the search server 114 to function as a geospatial search engine to incorporate distance, location discoverability, and user interest, among other factors, to rank discoverable items and POIs according to what is most likely to be relevant to a particular user at a given place and time. For instance, the relevance engine 116 uses process such as a general public relatedness, a distance weighted interest, and personal affinities, collaborative filtering, and behavioral analysis to determine a relevance of a discoverable item to a user based on the user's location, the time, and the user's personal affinities. An HTML server 120 serves the information as location discovery items to the client application 104 through the communications networks 106, according to any of a number of protocols including WAP push, TCP/IP, or any of a variety of wireless transmission protocols.

Each client application 104 is supported by a client platform 122, such as an operating system of a “smart phone” mobile device 130, or other mobile device system having advanced capabilities, particularly with GPS geo-location, computing and/or operating system, and display capabilities. A client authoring tool 128 provides web-based authoring and administration services to content Administrators, branding partners, location administrators, and other users of mobile devices or any web-enabled computing machine. Various components of the location discovery system 100 are described in further detail below.

### Server Environment

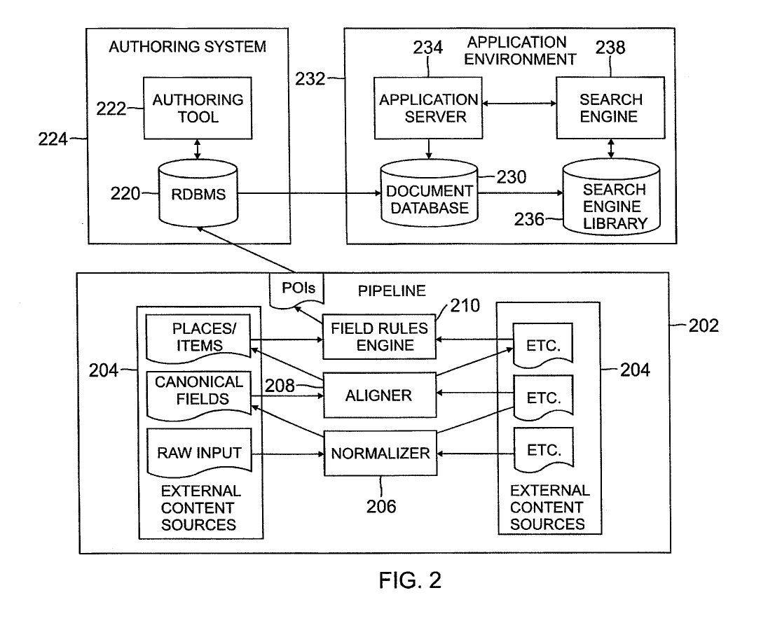

The feed processing components 118 normalize data feeds from multiple sources in order to build aggregated databases of POIs for use in the location discovery system 100. Together, the feed processing components 118 form a pipeline 202 as shown in FIG. 2, which illustrates an alternative functional view of a location discovery system 200. External content sources 204 provide data feeds (raw data, canonical fields, places/times, etc.) in which POIs are listed with source-specific identification and classification schemes, along with POI-associated data fields. Feed handlers, such as an aligner 208, apply rules specific to each source in order to align identifiers and classification schemes. This ensures that content for a given POI is associated correctly across sources even when POIs are characterized or represented differently among different sources. Another feed handler, a normalizer 206, normalizes source-specific data fields into a set of canonical fields used throughout the location discovery system 200. Normalized data is stored in a relational database 220 for use in an authoring system 222 of an authoring tool 224, for administrative purposes.

Normalized data is also stored in a ‘flat’ format in a document database 230, for quick retrieval and usage by a large number of client applications via a search engine library 236 and search engine 238 in a real-time application environment 232. At runtime, an application server 234 accesses data on behalf of a particular instance of a client application, and returns data appropriate to that client application (which may reflect a specific branding environment and/or user-specific settings).

### Content

The location discovery system 100 provides for the gradual accumulation of content from external sources, a partial list of which is provided below. Other sources may provide geo-tagged data for less traditional items such as U.S. mailboxes or movie shoot locations, for example. Certain data sources provide feeds that are processed and stored internally, while others provide access to their data via Web Services that are accessed at run-time.

### Core POI Data

The location discovery system 100 includes POIs of various types from a variety of sources that form the “core” of discoverable items. Major types and exemplary sources of POI data include:
Business POIs from local search engines and content managers.
Residential POIs from online real estate databases.
Area POIs (Cities, States, Neighborhoods, etc.) from government and other public databases.
Geographical features from private databases and data sources.
Landmarks from public and private databases.
Travel and Transit POIs from public and private databases.

### POI Groups

POIs may be part of one or more groups. All POIs in a group are collectively discovered when any member of the group is discovered. For instance, a house may be part of a tour group of “Star's Homes” or a Bus Stop maybe part of a group representing a route of bus stops.

### POI Data Fields

Data fields stored with each POI include identifying information such as Name, Address, Phone Number, website URL, Description, Logo image, Custom Map, as well as geo-tagging information (lat, long, elevation). A “geometry” associated with a POI can also be defined which represents its boundary region. It will be appreciated that the set of data fields can include other information associated with each POI.

A POI can be assigned a Chain ID, indicating that it is part of a chain such as a national food service franchise or coffee chain. Some data fields (such as logo) are stored at the chain level and inherited by POIs in the chain.

### POI Content

Various sources provide content for specific categories of POIs. Some major sources are listed below, though the list is not exhaustive. Some of those sources provide data via licensed data feeds, while other sources provide content that can be accessed from real simple syndicate (RSS) feeds or other Web-based APIs, and locally cached for quick retrieval.

### Online City Guides

The location discovery system 100 accesses various online city guides that provide a data feed of content primarily for city-specific retail locations such as restaurants, bars, hotels, and spas. Data includes operating information (hours of operation, payment methods, price range, parking, etc.), an overall rating, editorial and user reviews, and messages or other information from retail merchants themselves.

### Reviews

The location discovery system 100 accesses any of a number of online services for local search and reviews, to access editorial or user-entered reviews, for specific POIs from multiple Web-based APIs, and aggregates the reviews for consolidated display.

### News

The location discovery system 100 accesses geo-tagged news items from multiple Web-based APIs of news providers, and aggregates them for consolidated display. News items may be associated with a particular area (e.g. zip code or neighborhood) or with specific POIs.

### Events

The location discovery system 100 accesses geo-tagged events from multiple Web-based APIs and aggregates them for consolidated display. Event data is provided by any number of online services.

### Photos

The location discovery system 100 accesses photos for specific POIs from Web-based APIs associated with online photo sharing or photo hosting sites.

### Links

Content Administrators define links appropriate to particular taxonomies or specific POIs, so that certain pages can be displayed with links to associated information. For instance, “restaurant” pages can be displayed with links to reservation sites and nutritional information, or “movie theater” pages can be displayed with links to movie reviews and information, etc.

### Info POIs

Info POIs are pieces of information either associated with existing physical POIs, or which stand on their own as discoverable information.

### Location Blurbs

Some Info POIs associated with existing locations are called location blurbs. Location blurbs represent basic facts about a location (e.g. “SportCo in Los Angeles was founded in 1938.”) or may represent deals, specials, or other events associated with a location that have a defined time range associated with them.

### Area Blurbs

Other certain Info POIs are associated with an area (e.g. “Santa Monica was founded in 1875.”) In practice, these are similar location blurbs, since areas are themselves discoverable POIs.

### FYI Points

FYI Points are particular Info POIs that are not otherwise associated with existing physical locations. Examples would include celebrity sighting locations, or movie shoot locations.

### Virtual POIs

Virtual POIs include discoverable online electronic content such as geo-tagged blogs, Wikipedia articles, audio files or multimedia content.

### Advertisements

Advertisements are discoverable electronic content associated with a specific location or area POI. In using the general mechanism of relevance-based discovery to expose advertising content, the location discovery system 100 can be tuned to provide “vicinity sponsorship”, which determines advertisement content based on proximity to a particular location or location type.

### User-Contributed Content

Certain validated users, i.e. users of the location discovery system 100 that have registered and have performed certain activities for being validated by a system administrator, may contribute content, such as comments and ratings for particular POIs. The location discovery system 100 further allows users to create new POIs, which are discoverable by themselves and other users.

### Location Metadata

Various location metadata 112 is stored, for the purpose of classification, indexing, and determining behavior of the location discovery system 100. The location metadata 112 employs location ontology, containment, location taxonomy, inheritance, discoverability, chains, and other relationships and representations for metadata that describes location content, which are explained in more detail below.

### Location Ontology

An ontology is a formal representation of a set of concepts within a domain and the relationships between those concepts. A location ontology is used by the location discovery system 100 to represent the physical and semantic relationships between discoverable items or POIs (e.g. “discoverables”, or any entity that can be geo-tagged and thus discovered in a particular location-aware context, the term being interchangeably used herein with POI). Discoverables may be related to each other in a variety of ways, the configuration of which drives the behavior of the location discovery system 100.

### Containment

A major relationship modeled in the location ontology is that of containment. This is a recursive relationship, which allows the location discovery system 100 to represent recursive relationship or hierarchy among various individual discoverable POIs. As an example:
a State contains a City, which contains a Neighborhood, which contains a University Campus, which contains a Building, which contains a Classroom.
   Each of the items in the containment hierarchy is itself a discoverable entity having its own attributes and relations to other discoverable entities.

### Location Taxonomy

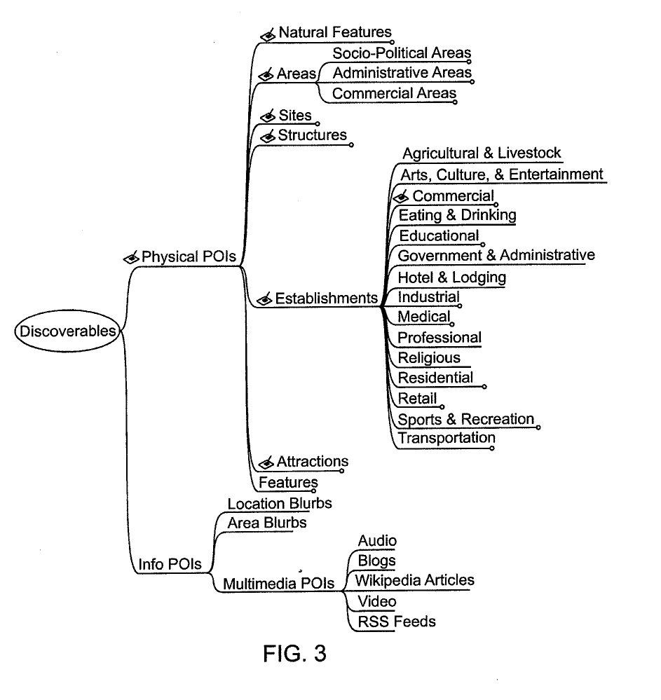

Another relation modeled in the location ontology is that of membership—often called “IS A”. This enables the location discovery system 100 to classify discoverables hierarchically. Accordingly, for instance: “Starbucks IS A Coffee Shop, which IS A Food and Drink Establishment, (etc.) . . . ” The structure that specifies these hierarchical relationships is the location taxonomy, one example of which is shown in FIG. 3. The location discovery system 100 employs a particular location taxonomy to classify items for discovery, and to enable other context-specific behavior. The most general distinction separates physical POIs from informational POIs. Each branch is then further classified. The most detailed branch of the taxonomy is a classification of “Establishments” (locations at which some kind of service is provided), and more specifically Business Establishments. Top level Establishment Types include Agricultural, Industrial, Commercial, Professional, Retail, etc. with again further specificity within each branch.

### Inheritance

Attributes of POI can be specified at any level of the taxonomy and inherited down its branches. In this way, location discovery system 100 behavior can be set at a general level and overridden with more specific exceptions. For example, it is possible to specify a high default discoverability for all Retail Establishments, with a lower value for specific, less common Retail Establishments such as, for instance, taxidermists.

### Discoverability

One aspect of the location taxonomy is its classification of items primarily according to their desired degree of discoverability. This is most prominent in the classification of businesses. Whereas previous business classification schemes have typically grouped businesses primarily by the product or service they offer (such as in an online ‘Yellow Pages’ directory), the location discovery system 100 employs a taxonomy that groups locations primarily by the type of activity occurring there. While a traditional classification might list ‘Ceramics-Manufacturing’, ‘Ceramics-Wholesale’, and ‘Ceramics-Retail’ together, the taxonomy used by the location discovery system 100 classifies Manufacturing, Wholesale, and Retail locations separately, and assigns a default level of discoverability to each of these, and then to specific business categories, products and service offerings within these groupings.

### Chains

A POIs Chain ID is a piece of metadata that effectively specifies an “ISA” relationship as if it were a most-specific taxon. So for instance “this Starbucks IS A Starbucks, which IS A Coffee Shop . . . ”. As with other POI metadata, the location discovery system 100 can learn a user's affinity for a particular location of a set of chain establishments.

### Search Categories

In addition to taxonomic classification, POIs may also be assigned to one or more search categories, which are configured for presentation to the user on the mobile device display in hierarchical “drill-down” fashion.

### Branded Categories

Search categories may be configured individually for each branding partner.

### Tags

Tags are descriptors associated with POIs, and represent general areas of interest like “Sports”, “Movies”, or “Architecture”, or specific features or amenities such as “Valet Parking” or “Free WiFi”. They are used in a location discovery method along with other metadata to determine what discoverables are most relevant to a user.

### Relevance Engine

Referring back to FIG. 1, the relevance engine 116 is a geospatial search engine that process factors of distance, location discoverability, and user interest in a proprietary way to rank discoverable items according to what is most likely to be relevant to a particular user at a given place and time, and to dynamically generate a relevance score for each POI. Location discoverability is initially assigned by content administrators based on a perceived “public interest” of particular taxonomies, or specific POIs, and can then be modified based on overall user activity in the location discovery system 100. Distance relates to a physical proximity between the user's actual location, as determined by their mobile device, and the POI(s).

User interest is based on the specific user's explicit and implicitly learned “affinity levels” for the metadata associated with a POI. For instance, a user might have a preference for particular chain restaurants, particular location types such as sushi restaurants, or locations associated with a particular tag such as “kids” or “pets”. The relative weights or priority of distance and user interest can be tuned as needed for different uses. In some implementations of a location discovery method, the relevance engine 116 will prioritize distance more heavily, while a user-initiated search for the user's favorite items will prioritize user interest more heavily. The relevance engine 116 employs proprietary heuristics to maximize the probability of returning “high-interest” items while minimizing search response time.

### Relevance Computation

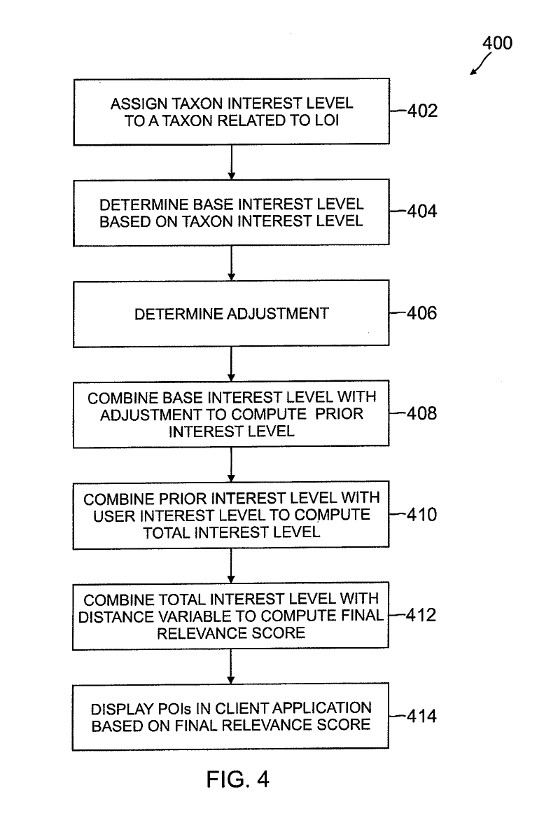

The relevance engine 116 computes a relevance score for a POI as shown in FIG. 4. At 402, a taxon interest level is assigned to a taxon related to each POI. In some implementations, the taxon interest level is assigned a value in a range (i.e. points between 1 to 1000) and may be manually assigned to a taxon based on perceived “public interest” of the taxon to an average user. For instance, eating and drinking establishments may be given a higher taxon interest level than manufacturing establishments, since most mobile device users search for the former type of establishments. These assignments are done initially by content administrators, and adjusted automatically after usage of the location discover system 100. If no taxon interest level is assigned to a taxon, it inherits the value from its parent taxon (and recursively up its branch) until an inherited taxon interest level is determined.

At 404 a base interest level is determined for each POI based the taxon interest level assigned to each POI, but may be overridden with a POI-specific value if one is assigned to such POI. At 406, an adjustment value is determined, based on various subjective factors such as whether the POI is brand-listed, whether the POI has value-added data content, i.e. from a third party online information source, or whether the POI has specific classifications, such as being “adult oriented” or the like.

At 408, the base interest level is combined with the adjustment to compute a prior interest level. At 410, the prior interest level is combined with a user interest level to compute a total interest level. The user interest level is a user-specific offset from the prior interest level, and can be positive or negative. In some implementations, the default value of the user interest level is 0. A user can affect their interest level for a particular POI (or the metadata associated with the POI) by performing various user actions in the client application such as “drilling-down” on the POI, or rating it “Thumbs Up” or “Thumbs Down” in a ratings scheme. In this manner, the location discovery system 100 learns a user's affinities for respective POIs, which are stored in the user's affinity profile.

The total interest level can be computed on a scale, i.e. from 1 to 2000, and once it is determined the total interest level value is sent with all POIs from the server to the client application, where it is combined with the variable distance to determine the final relevance score of a POI. This separation of server and client-side computations to arrive at a final relevance score allows for functionality that is not possible in a strictly server-side implementation, as is described in further detail below. The final relevance score is used to prioritize items for display in the client application, at 414.

### Display Templates

For presentation of content to the user, the location discovery system 100 allows for the creation of page templates, which are formed of a header and a configurable set of widgets. Each widget displays a particular type of data, such as reviews, news, or events. A template can be associated with any taxon and inherited to POIs with that taxon, or overridden by a template for a specific POI. For instance, all restaurants might share a default template, which can be overridden by a more specific template for specific types of restaurants such as Japanese restaurants, which would include information on Japan. Getting more granular, a sub-template for sushi restaurants might have information on environmentally sustainable fish types, which might then be overridden by a template for a specific restaurant such as “Tokyo Sushi House”. Templates are rendered into HTML pages and are sent from the server environment to the client application upon request.

### Authoring System

As illustrated in FIGS. 1 and 2, an authoring system 224 provides content administrators, branding partners, and location administrators the ability to create and manage content in the location discovery system 100. The authoring system 224 includes a Web-based interface (the authoring tool 222) to view and edit data stored in a relational authoring database 220. From the authoring database 220, content is published periodically to the document database 230, from where it can be provided to client applications via application server 234 or via search engine library 236 formed by search engine 238. Content administrators manage content used by the location discovery system 100 as a whole, including general POI and taxonomy-related content.

A location administrator may manage content relating to a particular location or chain of locations for which they have an association. This is referred to as “self-provisioning”. A location administrator may create and manage basic identifying information about their location, the geometry of which defines the bounding region of their physical premises, or the set of POIs contained by their location, which are themselves individually discoverable. For instance, a location administrator of a theme park might author items such as rides, concession stands, etc., to create a richly discoverable environment for users of the location discovery system 100 who visit the theme park. A location administrator may create and manage “Info POIs” associated with the location (i.e. via “Location Blurbs”). These may represent basic facts about the location, or specify deals, specials, or other time-based events, as described above. A location administrator may create and manage a “Global Mobile Web Site” as an HTML page, comprised of a template containing widgets that each retrieve and display a particular type of data. Branding partners may manage content related to their specific brand, such as branded ratings and branded location descriptions.

### Client Application

### Client-side Caching and Relevance Computation

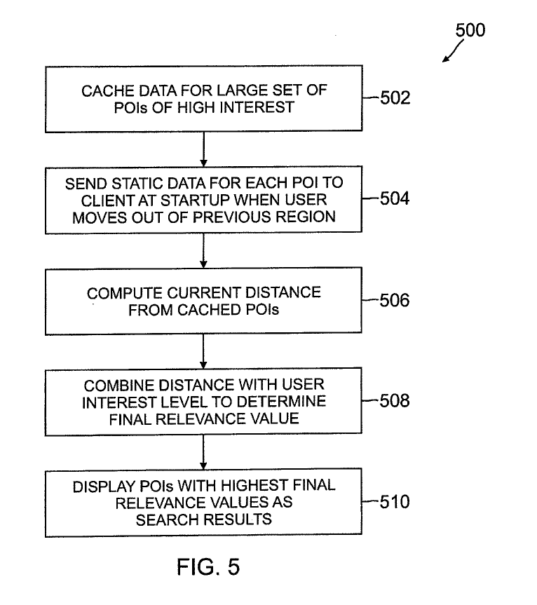

Typical client/server systems maximize the amount of computation performed on the server and returned to the client application for display. However, to perform a function such as location discovery in a large-scale multi-user environment where input parameters for each user change as the user moves, this could potentially put an extremely high computation burden on the server. To address this, the location discovery system 100 employs a client-side relevance computation approach. This is accomplished as shown in a client-side relevance computation method 500 shown in FIG. 5.

At 502, the client caches data for a large set of POIs that are likely to be of high-interest to an average user (i.e. they have a high default interest level, based on their classification in the location taxonomy). At 504, static data for each POI, including a user-specific interest level derived from the user's affinity profile, is sent to the client application at startup and then only when the mobile device has moved outside of the previously cached geographic region. At 506, the client application dynamically computes the user's current distance from POIs in the cache, and then combines this distance with user interest level to determine the final relevance score. POIs with the highest final relevance score are prioritized when displaying search results at 510. This approach minimizes the amount of data sent from the server environment to the client application, and allows for rapid re-prioritization of search results as a user moves—potentially rapidly—from one geographic environment to another.

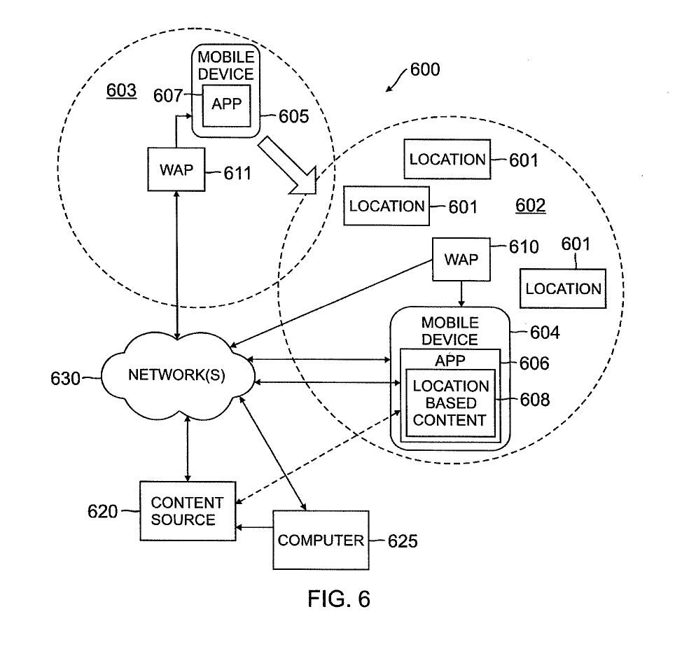

FIG. 6 is a block diagram of a system for determining and transmitting location-based content, i.e. content related to one or more locations 601 within a geographical area 602, from a content source 620 to a mobile device 604 via one or more communication networks 630. The mobile device 604 can include a location service, such as GPS, for determining its geographic location within geographical area 602 at any point in time. Such location service can also determine a geographic location of another mobile device 605 that is in another geographic area 603 that is different from geographic area 602, but which may be moving predictably toward geographic location 602. Each geographic area 602, 603 is associated with a wireless access point (WAP) 610, 611, respectively, that connects mobile devices 604, 605 with the one or more communications networks 630 by any of a number of known communication standards and protocols.

Each wireless device 604, 605, sends its location information to a computer 625, which may be a server or set of servers connected with the communications networks 630. The communications networks 630 can include any number of wired or, more particularly wireless, communication networks for communicating between the mobile devices 604, 605 and the computer 625. For example, communication networks 630 can be established and managed by a national “carrier,” or wireless communication service provider.

According to methods and techniques described above, the computer 625 implements a system for determining a context associated with each mobile device 604, 605. For example, the computer 625 can determine that mobile device 604 is within the geographic area 602, is near or within specific locations 601 (i.e. POIs or Info POIs), at a particular time of day. The computer 625 can further receive a history related to a user of the mobile device 604 as well as a user profile, to determine an affinity of the user to receive certain location-based content, and to determine a relevance of content in the content source 620 for matching the affinity, profile, history, or other user or location-specific data with relevant location-based content. This determines a context of the user associated with the The relevance of the location-based content can be determined dynamically, in real-time, by a relevance engine of the computer 625 as described above.

Once a context of the user of mobile device 604 is determined, the computer 625 sends the context to the content source 620. The content source 620 can be a database that is part of, or separate from, the computer 625, or part of another server or database. The content of the content source 620 can include one or more applications, such as discrete applications written for a particular software development kit (SDK) for a certain operating system such as Apple's OS or Google's Android operating systems, or may be instantiated in a dynamic, functional and feature-rich web page such as HTML5. The content can also include information about one or more “discoverables” such as POIs or Info POIs, as described above.

The content may also include one or more promotions, such as coupons, that are generated on-the-fly by a computer and assembled for use within a specific limited geographic region 602. The promotions can each be configured with a time limit for accepting the offer, a time limit for coming to the location to redeem the offer, and a limit for the number of redemptions by a certain number of users, or by other variables. In some examples, the promotion can be based on a user's context or past behavior, i.e. a user who is a regular recurring customer of a location 601 may be provided with a more enticing promotion than a user who is a rare customer of the same location 601. Likewise, a user can receive promotions that vary based on the context, as, for example, the computer 625 may generate a “40% off” coupon for a user who would previously receive a 60% discount, but for their context demonstrating that the user has not kept up with previous behavioral patterns. Furthermore, the computer 625 may generate promotions that could entice a user or set of users based on a context at any given time, i.e. time of day, number of user's within the geographic areas 602, 603, movement of a mobile device 605 from one geographical area 603 to another geographical area 602, mode of transportation, or any other contextual information about the user or group of users.

The content source 620, independently or in cooperation with computer 625 or other logic element, determines relevant location-based content from the content in the content source 620, and transmits or “pushes” that location-based content to the mobile device via network(s) 630, based on the context, to an application 606 or multiple applications running on the mobile device 604. The application 606 can be a browser, a webpage within the browser, or a local application that is downloaded from an online application “store” or loaded from an external memory source, or any other type of function-executing software program. The application 606 can run the location-based content as another application, and display a representation of the location-based content or the results of its functionality on a display of the mobile device 604.

One of the applications 606, 607 can include a navigation application, or connection with an API to a navigation system on, for example, an automobile. The system 200 can receive navigation information from the navigation system to generate contextual information such as distance from a location 601, or time for the user to arrive at the location 601 based on the user's present location and mode of conveyance (i.e. if the mobile device 605 is in a vehicle and traveling from one geographical area 603 to another geographical area 602 along a particular route, considering traffic or other road condition information).

The location-based content sent to the application 606 or 607 can be static information or dynamic information. In some implementations, the location-based content can be an RSS feed of current and/or real-time information. For example, the location-based content can be a continuous feed of information about latest news about a location 601. Or, if a location 601 is an airport, the location-based content can include continuously-updated flight times, schedules, gate information, etc. In another example, the dynamic information can be derived through an API to another system, such as a navigation system, which provides real-time traffic condition information.

Application 606 can be one or more distinct applications, and the location-based content can be shared among two or more applications 606. Two or more applications may be running at the same time on the mobile device 604, whether or not seen by the user. For example, a first application can be a shopping application related to a retail location 601, and the location-based content can fill the shopping application with contextual information about the preferences and affinities of a user of the mobile device 604, so as to enable the application to personalize its functionality. The shopping application, in turn, can share the contextual information about the user, including any new information about the user's purchasing habits, location, method of travel, other behaviors, time (i.e. any new contextual information) with a second application, such as a restaurant reservations application, to further enhance the second application's personalization for the user.

Each application 606, 607 or set of applications on each mobile device 604, 604, are preferably configured for a two-way communication of location-based information with the computer 625. The computer 625 directs the location-based content to be sent to the applications for providing the applications context, and the applications can gather additional information about users to be transmitted back to the content source 620 and computer 625 to continue building a behavioral profile and context for each of the users. The two-way communication can be established as continuous or asynchronous, i.e. any time there is new information to be exchanged, or at established intervals, i.e. at the conclusion of a session.

### User Interface

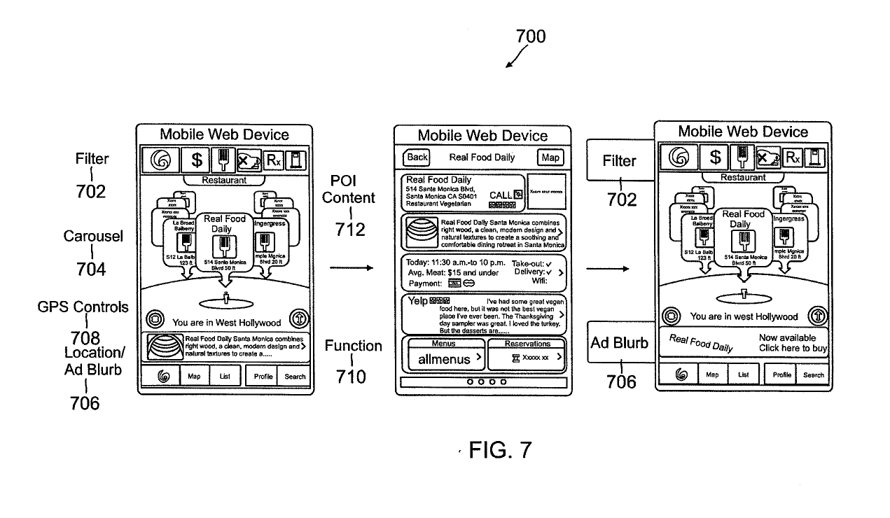

As shown in exemplary user interfaces 700 in FIG. 7, a user interface display on the mobile device can include a representations of a filter 702, a carousel 704 for visualizing primary and relevant location-based content, location or advertisement blurbs 706, GPS controls 708, and function controls 710 that enable input by a user to execute certain application-specific functions using the location-based content or according to the context. The user interfaces 700 allow for navigation among two or more applications that use the location-based content, or around one currently-running application that provides a set of functions for using the location-based content.

The location discovery methods result in a list of locations ordered by relevance, which is referred to herein as the user's “surroundings”. The client application provides multiple views of those surroundings on a display of the user's mobile device. Two of these are a “map view” that shows a representation of the physical location of each location, and a “list view” which shows a simple list of locations ordered by relevance. However, a “primary surroundings view” is a presentation interface called the location carousel 704. The location carousel 704 displays the surroundings as a circular list in three dimensions, and provides a touch-based interface for the user to easily ‘spin’ the carousel. The items in the carousel 704 are called “wafers,” each of which contain a combination of graphical and textual information about a location, such as name, logo, rating (i.e. a graphical representation of a rating from a content provider or branding partner), address, and/or distance from a current position of the mobile device.

The carousel 704 allows for items to be displayed with their size and accessibility proportional to their relevance; i.e. the most relevant item is largest, centered, and in the foreground, while less relevant items are smaller and represented as further away in the view to the user. The carousel can provide access to an arbitrarily large number of items without requiring more screen space: items can be made to appear out of the background, yet become larger as they approach the center, and then recede again into the background as the user navigates from one wafer to the next.

The content shown in the carousel 704 can be based on the concentration of categories of a certain type of business in the user's current area, as selected by a user from a graphical filter 702 that separates location-based content into a number of categories. For example, if the user's mobile device is on Sand Hill road, Venture Capital-related LOIs will get elevated. However if the user is in Palo Alto, which is a retail dominated area, the location discovery system 100 will configure the Venture Capital-related LOIs to not be displayed. Accordingly, the location of the mobile device can be used to tailor the carousel toward what types of LOIs are predominant in that location, or what a typical user may be looking for while in that location. In preferred implementations, the density of every kind of business within a given radius can be automatically calculated, and then the relative densities of various categories are used to increase the relevance of businesses (or other POIs) of that category, or possibly just recommend a change in view to something that shows only those POIs in the denser categories.

### Location and Context Data Path

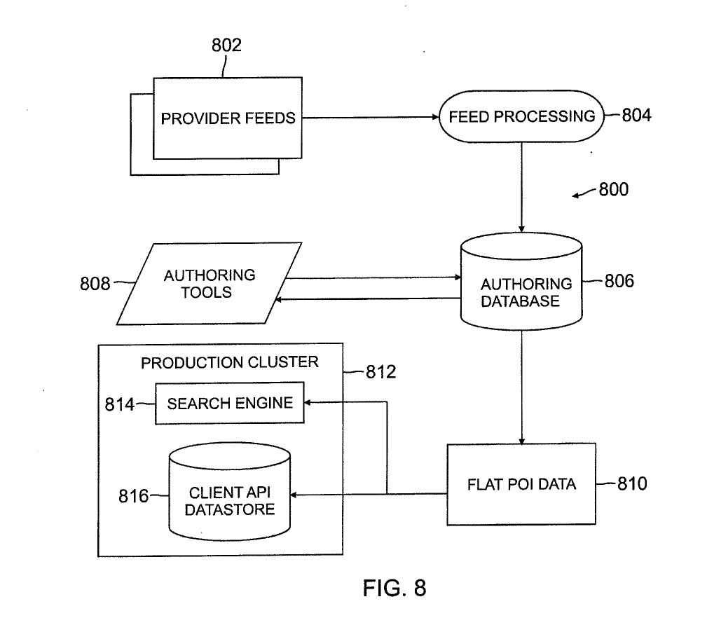

FIG. 8 is a functional block diagram of a system 800 for receiving and processing location data and contextual data. One or more data feeds 802 provide data to a location discovery system (such as 100, 200). The data feeds 802 can be application running on a mobile device, navigation systems, or other data sources. A feed processor 804 receives the data and processes it according to a data model, and applies data rules. The data, now processed according to a data model and a set of data rules, is stored in an authoring database 806.

Authors using authoring tools 808 create new POIs, or view and modify existing POIs from the data in the authoring database 806. POI data is “re-normalized” to product a flat version of the data in flat POI data 810, which is better suited for efficient access and delivery as location-based content. The flat POI data 810 is indexed for special and keyword processing by a production cluster 812, which can include a search engine 814 which receives user-inputted keywords to search a client API data store 816. Accordingly, the system is suited for continually updating a context for each user of each mobile device, for increased personalization of context-oriented applications.

### Personalization and Learning

A user's level of interest in a particular POI can be adjusted up or down based on their application usage. Specifically, weightings for the metadata associated with that POI are adjusted. This metadata can represent various aspects of the POI, including its chain (for national chains), its taxon (in the above-described location taxonomy), or other attributes (descriptive “tags” such as ‘pet-friendly’ or ‘family-friendly’). In this way the relevance engine can learn the user's preferences at varying degrees of specificity, to display particular banks over other banks for the LOI “banks” (as a whole) relative to other locations, or ‘pet-friendly’ locations in general. The client application can learn user affinities from specific actions such as drilling-down on a location, searching for a specific category or chain, or explicitly rating a location with a “Thumbs Up/Thumbs Down” user input interface. Learning can also be specific to the context. so if it is determined that in Airports a users always has a high interest in ordering beverages, this affinity may be recognized specifically when the user is in a transportation hub.

### Location-Based Content and Applications

A location discovery system triggers location-based content, giving location owners or other interested parties a platform for creating mobile experiences and establishing ongoing communication channels with customers. According to an aspect of some implementations, the location discovery system uses location information for a mobile device to trigger location-based content. The content can include an application that is selected and pushed to a mobile device according to a particular context related to the mobile device: i.e., the location of the mobile device, the time of day, the affinity and profile of a user of the mobile device, a behavioral history of the user, both with respect to one or more applications executed on the mobile device and with respect to general activities or search criteria, and other factors. Thus, the applications that are selected and pushed to a mobile device are known as contextual applications. A push can be done by the application requested to load an application, but the user does not specifically need to request the applications, but rather they are given the most likely relevant applications and interactivity. Contextual applications can take the form of discreet, self-aware and self-executing application code that is received by the mobile device and executed within an operating system environment or simply the form of new content which is loading into an existing application in a manner similar to how a browser loads a website Alternatively, a contextual application may take the form of a feature-rich website (such as those that could be coded in HTML5) that is received by the mobile device via a mobile device web browser or other local application. The contextual application can operate within or outside any local application, and the execution of which can be transitory or persistent on the mobile device, though in many cases will be loaded with contextual information on the user to allow for a personalized experience. For example, as long as the mobile device is within a particular geographical area, one or more contextual applications can be received by the mobile device for use by a user. When the mobile device is no longer within the geographic area, the one or more contextual applications disappear from the mobile device memory. Alternatively, the receipt, execution and deletion of contextual applications can be based on any combination of present activity and behavioral history of the user as based on location, time or other contextual information.

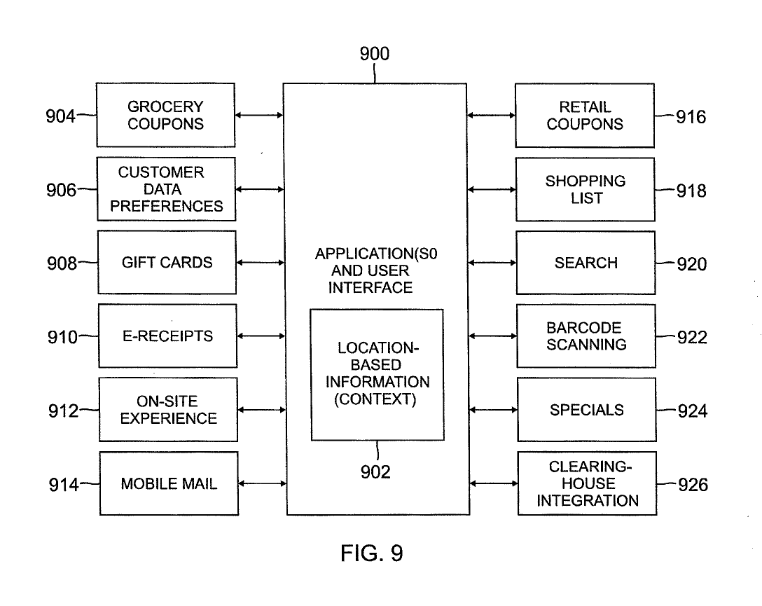

FIG. 9 is a functional block diagram of a promotions contextual application environment, in accordance with the presently described systems and methods. One or more applications 900 each execute an application on a mobile device, and provide an interactive user interface. The user interface can provide a “touch” navigable screen, or by navigable using any of a number of buttons or controls on a mobile device, such as a scroll wheel, cursor pad, etc. The location discovery system can populate the one or more applications with location-based information 902 to provide a context and a personalization for the one or more applications 900 and user interfaces.

The application environment includes a number of modules that accumulate data and generate promotional functions, such as grocery coupons 904, customer data preferences 906, gift cards 908, electronic receipts 910, location-based on-site experience data 912, and/or mobile mail 914 tied to the other modules or the context. The application environment can also include other promotional modules such as retail coupons 916, a shopping list generator 918, a search tool 920, barcode scanner 922, specials 924 and clearing house integration 926. Each of these modules may be a separate application that is integrated with the other modules within the promotional environment, and all using information derived from a common location-based information source 902.

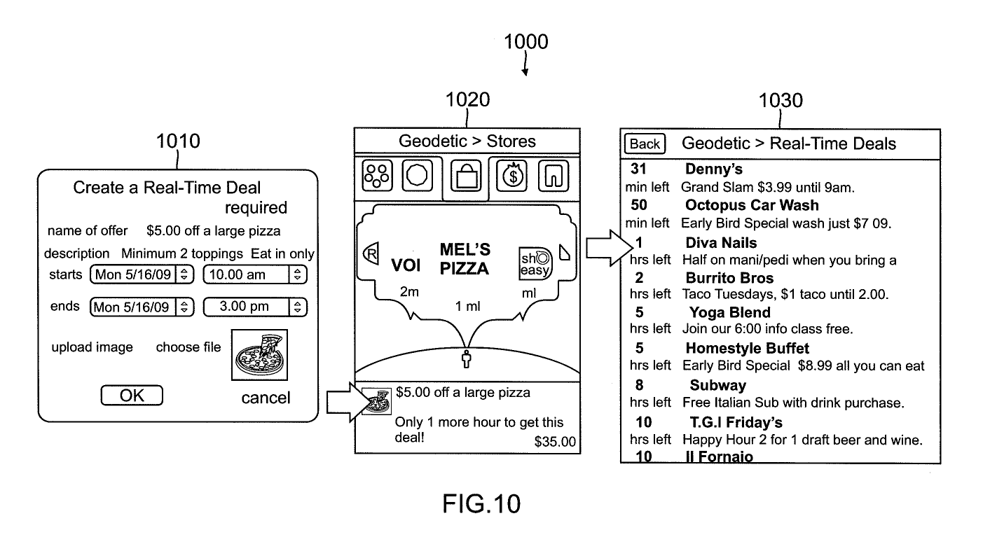

FIG. 10 is a diagram 1000 illustrating the generation and distribution of a coupon. In connection with interface 1100, the user is able to select parameters regarding a new coupon to publish/distribute such as a time period in which the coupon is valid, and an amount of a corresponding discount. Moreover, interface 1100 can allow the user to upload one or more graphic images corresponding to the coupon (thumbnail size, larger screen size, etc.). Once the coupon is initiated, it can be displayed in a variety of fashions such as that in user interface 1020 in which coupons from a plurality of vendors are illustrated in a slide carousel format (and are rotatable via user input) and user interface 1030 in which coupons are provided in list format. In the latter arrangement, the coupons can be sorted based on factors such as expiration time, alphabetical order, geographic location, and the like.

Some or all of the functional operations described in this specification can be implemented in digital electronic circuitry, or in computer software, firmware, or hardware, including the structures disclosed in this specification and their structural equivalents, or in combinations of them. Implementations can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate implementations, may also be provided in combination in a single implementation. Conversely, various features which, for brevity, are described in the context of a single implementation, may also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular implementations of the invention have been described. Other implementations are within the scope of the following claims. For example, the steps recited in the claims can be performed in a different order and still achieve desirable results. In addition, implementations of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A method comprising:
receiving, at a computer, location information associated with a mobile device;
determining, by the computer, a context associated with the mobile device;
sending the context to a content source;
determining, by the content source, location-based content based on the context, the location-based content including a promotion for a location associated with the location-based content; and
transmitting, from the content source via a mobile communications network, the location-based content to an application running on the mobile device, the application being configured to display a representation of the location-based content on a display of the mobile device and to execute a promotional function based on the promotion.

2. The method in accordance with claim 1, wherein the location is a merchant location, wherein the promotion is a digital coupon, and wherein the promotional function includes deducting a value of the digital coupon from a purchase transaction executed at the merchant location using the mobile device.

3. The method in accordance with claim 1, wherein the promotion includes a time limit and a geographic area limit to a location within a geographic area.

4. The method in accordance with claim 2, wherein the value deducted for a specific user is based a usage pattern associated with the user.

5. The method in accordance with claim 1, wherein a distribution of where the coupon is presented is based on one or more of: user viewing patterns, redemption patterns, implicit user preferences, and user-defined preferences.

6. The method in accordance with claim 1, further comprising executing, by a purchase transaction application running on the mobile device, a purchase transaction at the location, the purchase transaction including the promotional function.

7. A method comprising:
determining a location of a mobile device;
transmitting location information associated with the location to a server computer via a wireless communications network;
transmitting user identification information associated with a user of the mobile device to the server computer via the wireless communications network;
running one or more location-based applications on the mobile device;
receiving, by at least one of the one or more location-based applications from the server computer via the wireless communications network, location-based content based on a context determined by the server computer, the location-based content including a promotion for a location associated with the location-based content; and
executing, by the at least one application, a promotional function based on the promotion.

8. The method in accordance with claim 7, further comprising displaying, by the at least one application, a representation of the location based content in a display of the mobile device.

9. The method in accordance with claim 7, wherein the location is a merchant location, wherein the promotion is a digital coupon, and wherein the promotional function includes deducting a value of the digital coupon from a purchase transaction executed at the merchant location using the mobile device.

10. The method in accordance with claim 7, wherein the promotion includes a time limit and a geographic area limit to a location within a geographic area.

11. The method in accordance with claim 9, wherein the value deducted for a specific user is based on a usage pattern associated with the user.

12. The method in accordance with claim 9, wherein the merchant location is a grocery store.

13. The method in accordance with claim 7, further comprising executing, by a purchase transaction application running on the mobile device, a purchase transaction at the location, the purchase transaction including the promotional function.

14. The method in accordance with claim 7, wherein the location-based content includes information about the location.

15. The method in accordance with claim 14, wherein the information about the location is updated according to movement of the mobile device from the location to another location.

16. A method comprising:
running one or more location-based applications on the mobile device;
receiving, by at least one of the one or more location-based applications from a server computer via the wireless communications network, location-based content based on a context determined by the server computer, the location-based content including a promotion associated with the location-based content, the context being based on a location of the mobile device and a historical profile of a user of the mobile device;
accessing, by the at least one location-based application, the location-based content to execute the promotion to generate a promotional function that is personalized for the user of the mobile device based on the context;
executing, by the at least one application, the promotional function based an input from the user of the mobile device.

17. The method in accordance with claim 16, wherein the location is a merchant location, wherein the promotion is a digital coupon, and wherein the promotional function includes deducting a value of the digital coupon from a purchase transaction executed at the merchant location using the mobile device.

18. The method in accordance with claim 16, wherein the promotion includes a time limit and a geographic area limit to a location within a geographic area.

19. The method in accordance with claim 18, wherein the value deducted for a specific user is based on a usage pattern associated with the user.

20. The method in accordance with claim 16, wherein the location-based content includes information about the location that is updated according to movement of the mobile device from the location to another location.
